(19) United States
(12) Patent Application Publication
(10) Pub. No.: US 2024/0283550 A1
(43) Pub. Date: Aug. 22, 2024

(54) DISPLAY PROCESSING DEVICE AND DISPLAY PROCESSING METHOD

(71) Applicant: Furuno Electric Co., Ltd., Nishinomiya-City (JP)

(72) Inventor: Daisuke KIMURA, Ashiya (JP)

(73) Assignee: Furuno Electric Co., Ltd., Nishinomiya-City (JP)

(21) Appl. No.: 18/654,100

(22) Filed: May 3, 2024

Related U.S. Application Data
(63) Continuation-in-part of application No. PCT/JP2022/014833, filed on Mar. 28, 2022.

(30) Foreign Application Priority Data
Nov. 8, 2021 (JP) 2021-181704

(51) Int. Cl. H04B 17/23; H04B 1/06; H04B 17/309

(52) U.S. Cl. CPC H04B 17/23; H04B 1/06; H04B 17/346

(57) ABSTRACT

A display processing device capable of preventing generation of interference when performing voice wireless communications between a plurality of ships, or between a ship and a land station, and making normal voice wireless communications start smoothly, is provided. The display processing device includes a receiver and processing circuitry. The receiver receives a radio wave for voice. The processing circuitry performs a determination of a channel used for propagation of the radio wave for voice and a ship/land determination for determining whether an output source of the radio wave for voice is either one of a ship and a land station. The processing circuitry displays, on a screen indicative of a time-series change in the status of use for every channel that may be used, a result of the ship/land determination for the used channel.

### CROSS-REFERENCE TO RELATED APPLICATION(S)

This application is a continuation-in-part application of PCT International Application No. PCT/JP2022/014833, which was filed on Mar. 28, 2022, and which claims priority to Japanese Patent Application No. JP2021-181704 filed on Nov. 8, 2021, the entire disclosures of each of which are herein incorporated by reference for all purposes.

### TECHNICAL FIELD

The present disclosure relates to a display processing device and a display processing method.

### BACKGROUND OF THE DISCLOSURE

Conventionally, when performing voice wireless communications between a plurality of ships, or between a ship and a land station, their users talk using a common channel defined beforehand and determine an exclusive channel to be used for the voice wireless communications. Then, each user changes the channel to be used from the common channel to the exclusive channel, and performs the voice wireless communications using the exclusive channel.

However, the determined exclusive channel may have already been used by others. In such a case, since radio wave for voice containing voice data transmitted from each wireless radio which performs the voice wireless communications interferes with radio wave transmitted from other wireless radios which have already used this exclusive channel, it becomes difficult to catch the conversation voices. Therefore, the voice wireless communications become difficult to perform normally. For this reason, it becomes necessary to again determine the exclusive channel between the users, which requires more time and effort.

### SUMMARY OF THE DISCLOSURE

Thus, the present disclosure is made in order to solve the above-described problem, and one purpose thereof is to provide a display processing device and a display processing method, capable of preventing generation of interference of voice wireless communications between a plurality of ships, or between a ship and a land station, to make normal voice wireless communications start smoothly.

In order to solve the above-described problem, a display processing device according to one aspect of the present disclosure includes a receiver, an analysis processor, and a display processor. The receiver receives a radio wave for voice. The analysis processor performs a determination of a channel used for propagation of the radio wave for voice and a ship/land determination for determining whether an output source of the radio wave for voice is either one of a ship and a land station. The display processor displays, on a screen indicative of a time-series change in the status of use for every channel that may be used, a result of the ship/land determination for the used channel.

Thus, according to the configuration for displaying the screen indicative of the time-series change in the status of use for every channel which may be used, a user of each wireless radio which performs voice wireless communications can select an exclusive channel, after grasping a currently-used channel by checking the screen displayed by the display processing device.

Further, according to the configuration for displaying on the screen whether the output source of the radio wave for voice is either a ship or a land station, the user of each wireless radio can estimate the purpose of use of the currently-used channel, and thus can select a more suitable exclusive channel. Therefore, the interference when performing the voice wireless communications between a plurality of ships, or between a ship and a land station can be prevented, and normal voice wireless communications can be started smoothly.

According to the present disclosure, it becomes possible to prevent the generation of interference of voice wireless communications between a plurality of ships, or between a ship and a land station, to make normal voice wireless communications start smoothly.

### BRIEF DESCRIPTION OF DRAWINGS

The present disclosure is illustrated by way of example and not by way of limitation in the figures of the accompanying drawings, in which like reference numerals indicate like elements and in which:

FIG. 1 is a sequence diagram illustrating a procedure when starting voice wireless communications between wireless radios;

FIG. 2 is a sequence diagram illustrating a problem when starting the voice wireless communications between wireless radios;

FIG. 3 is a view illustrating a configuration of a display processing device according to one embodiment of the present disclosure;

FIG. 4 is a view illustrating one example of a screen displayed by a display processor in the display processing device according to the embodiment of the present disclosure;

FIG. 5 is a view illustrating another example of the screen displayed by the display processor in the display processing device according to the embodiment of the present disclosure;

FIG. 6 is a view illustrating another example of the screen displayed by the display processor in the display processing device according to the embodiment of the present disclosure; and

FIG. 7 is a flowchart defining one example of an operation procedure when the display processing device according to the embodiment of the present disclosure displays a screen indicative of a time-series change in the status of use for every channel.

### DETAILED DESCRIPTION OF THE DISCLOSURE

Hereinafter, one embodiment of the present disclosure is described with reference to the accompanying drawings. Note that the same reference characters are given to the same or corresponding parts in the drawings not to repeat the same explanation. Further, at least some parts of the embodiment described below may be combined arbitrarily.

<Start Procedure of Voice Wireless Communications between Wireless Radios>

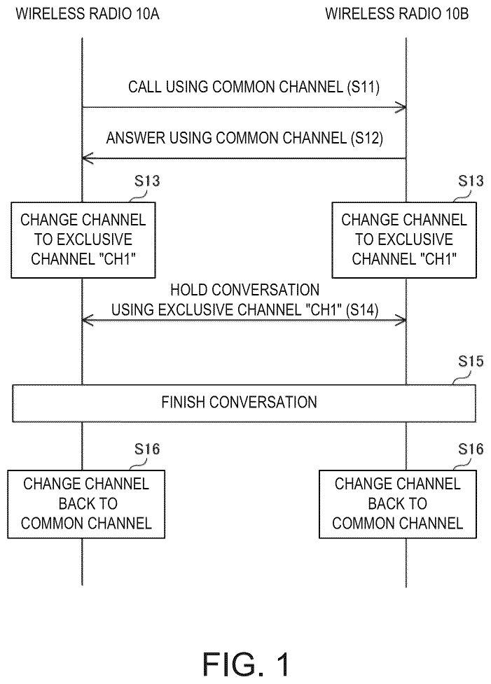

FIG. 1 is a sequence diagram illustrating a procedure when starting voice wireless communications between wireless radios. Here, a case where two wireless radios 10 (wireless radios 10A and 10B) perform voice wireless communications is described. At least one of the wireless radios 10A and 10B is provided to a ship.

Referring to FIG. 1, first, the wireless radio 10A transmits to the wireless radio 10B a radio wave for voice containing voice data for calling for use of a channel “CH1” corresponding to a certain frequency band as an exclusive channel, using a common channel “CH16” which is a frequency band appointed beforehand, according to operation by a user A who is a user of the wireless radio 10A (Step S11).

Next, in response to the call from the wireless radio 10A, the wireless radio 10B transmits to the wireless radio 10A a radio wave for voice containing voice data for answering for the use of the channel “CH1” as the exclusive channel, using the common channel “CH16,” according to operation by a user B who is a user of the wireless radio 10B (Step S12).

Next, the wireless radios 10A and 10B change the channel to be used from the common channel “CH16” to the exclusive channel “CH1” according to the operation by the users A and B (Step S13).

Next, the wireless radios 10A and 10B transmit and receive a radio wave for voice using the exclusive channel “CH1.” Therefore, conversation is held between the users A and B (Step S14).

Next, when the conversation between the users A and B is finished (Step S15), the wireless radios 10A and 10B change the channel to be used back from the exclusive channel “CH1” to the common channel “CH16” according to operation by the users A and B (Step S16).

### Explanation of Problem

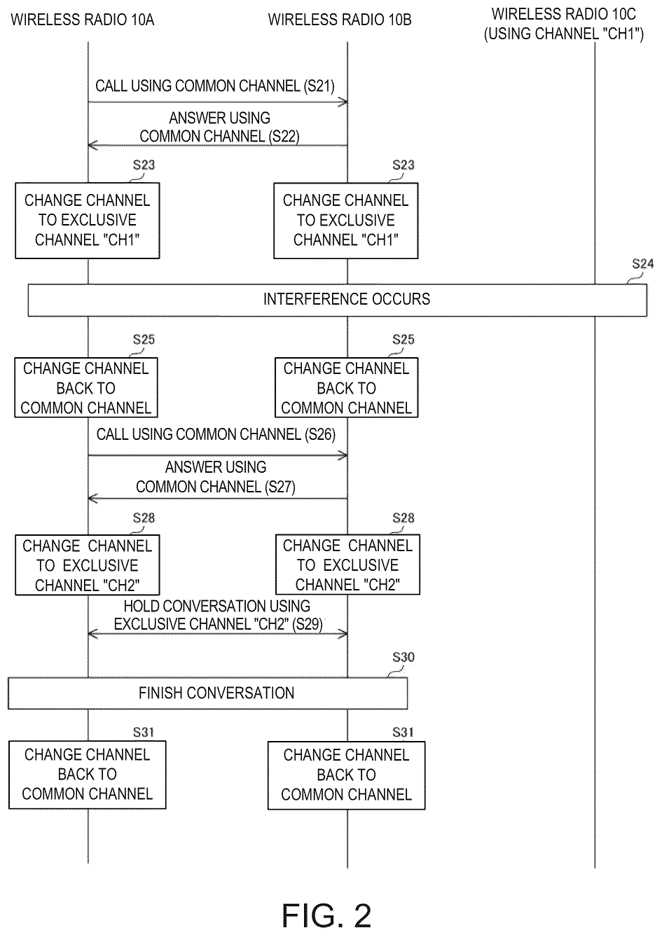

FIG. 2 is a sequence diagram illustrating a problem when starting the voice wireless communications between the wireless radios. Here, a case where the two wireless radios 10A and 10B perform the voice wireless communications is described, similarly to the case illustrated in FIG. 1.

Referring to FIG. 2, since operation from Step S21 to Step S23 is similar to the operation from Step S11 to Step S13 illustrated in FIG. 1, the detailed explanation will not be repeated herein.

Here, the channel “CH1” which is used by the wireless radios 10A and 10B as the exclusive channel has already been used by a wireless radio 10C which is a wireless radio 10 provided to a ship or a land station. In this case, when the wireless radios 10A and 10B transmit a radio wave for voice using the channel “CH1,” since the radio wave for voice from each of the wireless radios 10A and 10B interferes with a radio wave from the wireless radio 10C, it becomes difficult to catch the conversation voices. Therefore, the voice wireless communications become difficult to perform normally (Step S24).

For this reason, the wireless radios 10A and 10B change the channel to be used back from the exclusive channel “CH1” to the common channel “CH16” according to operation by the users A and B (Step S25).

Next, the wireless radio 10A transmits to the wireless radio 10B a radio wave for voice containing voice data for calling for use of a channel “CH2” corresponding to another frequency band as the exclusive channel, using the common channel “CH16,” according to operation by the user A (Step S26).

Next, in response to the call from the wireless radio 10A, the wireless radio 10B transmits to the wireless radio 10A a radio wave for voice containing voice data for answering for the use of the channel “CH2” as the exclusive channel, using the common channel “CH16,” according to operation by the user B (Step S27).

Next, the wireless radios 10A and 10B change the channel to be used from the common channel “CH16” to the exclusive channel “CH2” according to operation by the users A and B (Step S28), and they transmit and receive a radio wave for voice using the exclusive channel “CH2.” Therefore, conversation is held between the users A and B (Step S29).

Next, when the conversation between the users A and B is finished (Step S30), the wireless radios 10A and 10B change the channel to be used back from the exclusive channel “CH2” to the common channel “CH16” according to operation by the users A and B (Step S31).

Thus, when the exclusive channel determined between the users has already been used by others, it is necessary to again determine the exclusive channel between the users, and it requires more time and effort in order to perform normal voice wireless communications. Further, since the wireless radio 10 is generally limited by its hardware configuration in the number of channels which can be used simultaneously, it is difficult to grasp in parallel the status of use of all the usable channels.

Therefore, a display processing device 201 according to the embodiment of the present disclosure solves such a problem by following configuration and operation.

### <Display Processing Device According to Embodiment of Present Disclosure>

### [Configuration and Basic Operation]

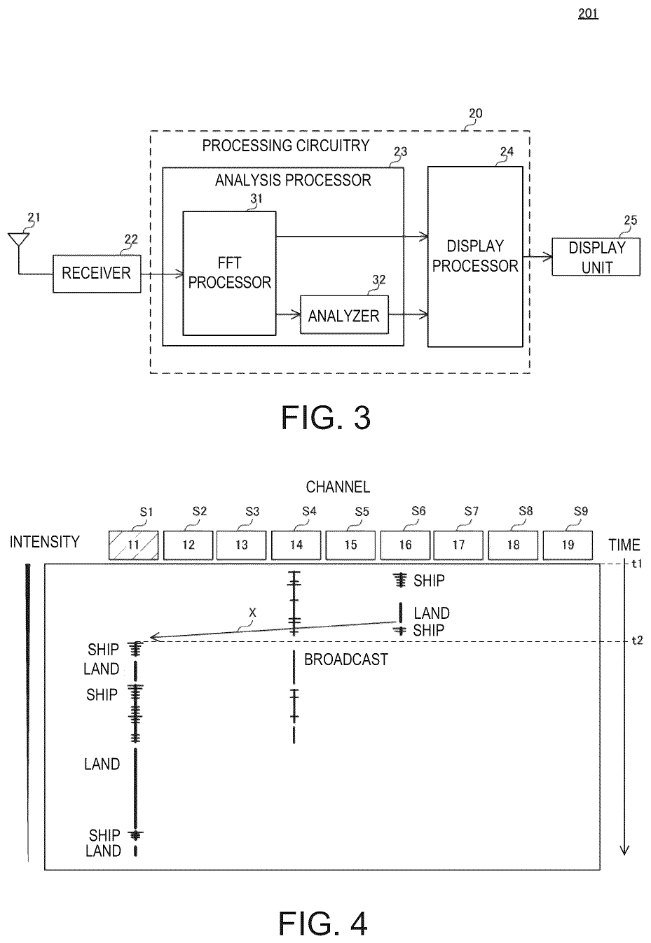

FIG. 3 is a view illustrating a configuration of the display processing device according to the embodiment of the present disclosure. The display processing device 201 may be provided to a ship and a monitoring center of a land station, and may display on a screen the status of use of each channel which may be used by the wireless radio 10. The user of each wireless radio 10 can select the exclusive channel after grasping the currently-used channel by checking the screen displayed by the display processing device 201.

In more detail, referring to FIG. 3, the display processing device 201 may include a processing circuitry 20, an antenna 21, a receiver 22, and a display unit 25. The processing circuitry 20 may include an analysis processor 23 and a display processor 24. The analysis processor 23 may include an FFT processor 31 and an analyzer 32. The processing circuitry 20 may be processing circuitry, for example.

The receiver 22 may receive via the antenna 21 the radio wave for voice containing voice data transmitted from the wireless radio 10, convert the received radio wave for voice into a digital signal, and output it to the analysis processor 23. The voice data may be vocal waveform data, for example.

The FFT processor 31 in the analysis processor 23 may generate a power spectrum by periodically or irregularly performing FFT processing to the digital signal received from the receiver 22, and output the generated power spectrum to the analyzer 32 and the display processor 24.

The analyzer 32 may determine periodically or irregularly, based on the power spectrum outputted from the FFT processor 31, the channel used for propagation of the radio wave for voice received by the receiver 22, and output the determination result to the display processor 24. For example, when a frequency component is contained at more than a certain level (signal strength) in the radio wave for voice, the analyzer 32 may determine that the channel corresponding to this frequency component is used.

The display processor 24 may display a screen indicative of a time-series change in the status of use on the display unit 25 for every channel which may be used, based on the power spectrum outputted from the FFT processor 31 and the result of the channel determination outputted from the analyzer 32.

FIG. 4 is a view illustrating one example of the screen displayed by the display processor in the display processing device according to the embodiment of the present disclosure. Referring to FIG. 4, the display processor 24 may display a screen indicative of the spectrum classified by color according to the level of the corresponding frequency component for every channel which may be used. In FIG. 4, instead of the classification by color, the level is illustrated by a difference in the thickness of a line of the spectrum.

Note that, instead of displaying the screen indicative of the spectrum classified by color according to the level of the frequency component, the display processor 24 may display a screen indicative of the spectrum in which the thickness of the line differs according to the level of the frequency component, as illustrated in FIG. 4.

Further, the display processor 24 may display in the screen a plurality of channels which may be used. For example, the display processor 24 may display in the screen graphic symbols S1-S9 respectively corresponding to channels “CH11” to “CH19.”

Here, the common channel may be “CH16.” Further, here, the wireless radio 10A may be provided to a ship, and the wireless radio 10B may be provided to a land station. Further, the user A of the wireless radio 10A and the user B of the wireless radio 10B may have held conversation for determining the channel “CH11” as the exclusive channel, by using the common channel “CH16” during a period from Time t1 to Time t2. In this case, according to the screen displayed by the display processor 24, the fact that the radio wave for voice is transmitted intermittently using the common channel “CH16” during the period from Time t1 to Time t2 may be illustrated.

Further, here, the users A and B may have held conversation by voice wireless communications using the exclusive channel “CH11” during a period after Time t2. In this case, according to the screen displayed by the display processor 24, the fact that the radio wave for voice is transmitted intermittently using the exclusive channel “CH11” during the period after Time t2 may be illustrated.

### [Various Determinations by Analyzer and Indication by Display Processor]

The analyzer 32 may further perform various determinations about the radio wave for voice, in addition to the determination of the channel used for the propagation of the radio wave for voice. Below, the determination for the radio wave for voice performed by the analyzer 32, and the indication by the display processor 24 are described in detail.

### (Ship/Land Determination)

The analyzer 32 may perform a ship/land determination for determining whether an output source of the radio wave for voice received by the receiver 22 is either a ship or a land station. In detail, the analyzer 32 may perform the ship/land determination based on a degree of noise in the radio wave for voice received by the receiver 22.

In more detail, the radio wave for voice from a ship may tend to contain data of sound at frequencies outside human voice frequencies, such as engine sound, and tend to have a larger degree of noise due to frequency fluctuation than the radio wave for voice from a land station.

For this reason, in the ship/land determination, when the degree of noise in the radio wave for voice received by the receiver 22 is larger than a given reference value, the analyzer 32 may determine that the transmission source of the radio wave for voice is a ship.

On the other hand, in the ship/land determination, when the degree of noise in the radio wave for voice received by the receiver 22 is below the given reference value, the analyzer 32 may determine that the transmission source of this radio wave for voice is a land station. Then, the analyzer 32 may notify the display processor 24 about the determination result of the ship/land determination, and the determination result of the channel used for the radio wave for voice which is the determination target.

When the notice from the analyzer 32 is received, the display processor 24 may display the result of the ship/land determination by the analyzer 32 on the screen based on this notice. In detail, as illustrated in FIG. 4, for the radio wave for voice of which the transmission source is a ship and which uses the channel “CH16,” the display processor 24 may display the text “SHIP” around the corresponding frequency component in the screen. For the radio wave for voice of which the transmission source is a land station and which uses the channel “CH16,” the display processor 24 may display the text “LAND” around the corresponding frequency component in the screen.

### (Broadcast Determination)

The analyzer 32 may perform a broadcast determination for determining whether the radio wave for voice received by the receiver 22 is a radio wave used for broadcast from a land station. In more detail, the analyzer 32 may perform the ship/land determination, and if it detects that the radio wave for voice from the land station is continuously received by the receiver 22 for more than a given period of time, it may determine that this radio wave for voice is the radio wave used for broadcast from the land station. Then, the analyzer 32 may notify the display processor 24 about the determination result of the broadcast determination, and the determination result of the channel used for the radio wave for voice which is the determination target.

Note that, even if the radio wave for voice from the land station has not been received temporarily, the analyzer 32 may determine that the radio wave for voice from the land station is continuously received, if the length of the non-receiving period is shorter than the given period.

When the notice from the analyzer 32 is received, the display processor 24 may display the result of the ship/land determination by the analyzer 32 on the screen based on this notice. In detail, as illustrated in FIG. 4, for the radio wave for voice used for the broadcast from the land station and transmitted using the channel “CH14,” the display processor 24 may display the text “BROADCAST” around the corresponding frequency component in the screen.

### (Channel Change Determination)

When the radio waves for voice from the same ship are continuously received by the receiver 22 between different channels, the analyzer 32 may perform a channel change determination for determining that a change in the channel is made in this ship.

In more detail, the analyzer 32 may perform the determination of the channel and the ship/land determination, and identify a reception end time at the receiver 22 of the radio wave for voice from a ship in a first channel. Further, the analyzer 32 may perform the determination of the channel and the ship/land determination, and identify a reception start time at the receiver 22 of the radio wave for voice from a ship in a second channel after the reception end time.

Then, if a difference between the identified reception end time and reception start time is less than a given value, the analyzer 32 may determine that the radio waves for voice from the same ship are continuously received by the receiver 22 between different channels. In this case, the analyzer 32 may determine that the change in the channel is made in this ship.

Then, the analyzer 32 may notify the display processor 24 the result of the channel change determination, the channel before the change, the channel after the change, and at least one of the identified reception end time and reception start time.

When the notice from the analyzer 32 is received, the display processor 24 may display the result of the channel change determination by the analyzer 32 on the screen based on the notice.

In detail, here, the display processor 24 may have received from the analyzer 32 a notice indicating that the channel is changed from “CH16” to “CH11,” and the reception start time of the radio wave for voice using the channel “CH11” is Time t2. In this case, as illustrated in FIG. 4, the display processor 24 may display on the screen an arrow X indicating that the channel is changed from “CH16” to “CH11” just before Time t2.

Note that the analyzer 32 may perform the channel change determination using other methods. For example, the radio waves for voice transmitted from the same ship tend to have the same degree of noise. For this reason, the analyzer 32 may analyze the noise in the radio wave for voice received by the receiver 22, and based on the analysis result, it may determine that the radio waves for voice from the same ship are continuously received by the receiver 22 between different channels.

Further, the analysis processor 23 may be provided with a voice recognizer (not illustrated), and the voice recognizer may analyze voice data contained in the radio wave for voice received by the receiver 22, instead of the analyzer 32, and determine whether the change in the channel is made in the ship based on this analysis result.

In more detail, the voice recognizer may convert the voice data contained in the radio wave for voice into a text format and output it. When the outputted text contains text, such as “CHANNEL” and “CHANGE,” the voice recognizer may determine that the change in the channel is made in the ship which is the transmission source of the radio wave for voice. Then, the voice recognizer may output the determination result to the analyzer 32, and the analyzer 32 may notify the display processor 24 about the determination result from the voice recognizer.

### (Indication of Available Channel)

The display processor 24 may further recognizably display on the screen a channel which is not currently used. For example, the display processor 24 may turn off light of a graphic symbol S corresponding to the currently-used channel among the graphic symbols S1-S9 indicated in the screen corresponding to the respective channels “CH11” to “CH19,” and turn on light of a graphic symbol S corresponding to the currently-unused channel.

In FIG. 4, the graphic symbol S1 corresponding to the currently-used channel “CH11” is hatched in order to indicate that the light is turned off, while the graphic symbols S2-S9 corresponding to the currently-unused channels “CH12” to “CH19” are not hatched in order to indicate that the light is on.

### (Change in Display Period)

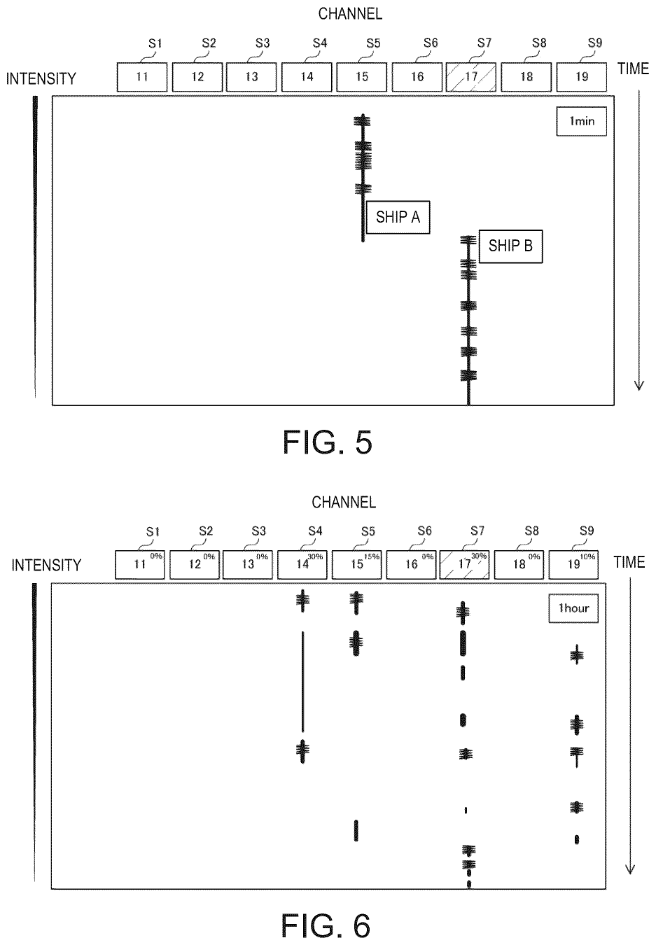

FIGS. 5 and 6 are views illustrating another example of the screen displayed by the display processor in the display processing device according to the embodiment of the present disclosure.

Referring to FIGS. 5 and 6, the display processor 24 may be acceptable of operation by the user of the display processing device 201. For example, as illustrated in FIG. 5, when operation for setting the display period of the screen to one minute is performed by the user, the display processor 24 may display the screen indicative of the status of use of each channel for the last one minute based on the power spectrum from the FFT processor 31 and the result of the channel determination from the analyzer 32.

Further, for example, as illustrated in FIG. 6, when operation for setting the display period of the screen to one hour is performed by the user, the display processor 24 may display the screen indicative of the status of use of each channel in the latest one hour based on the power spectrum from the FFT processor 31 and the result of the channel determination from the analyzer 32.

### (Plural Ships Determination)

Referring back to FIG. 5, the analyzer 32 may make a plural ships determination for determining whether several mutually different channels are respectively used for the propagation of the radio waves for voice from a plurality of ships.

In more detail, the wireless radio 10 cannot use mutually different channels simultaneously. For this reason, the analyzer 32 may perform the channel determination and the ship/land determination, and when a plurality of radio waves for voice from ships which use different channels are received by the receiver 22 at the same time, it may determine that the plurality of radio waves for voice are transmitted from a plurality of ships, respectively. Then, the analyzer 32 may notify the display processor 24 about the determination result of the plural ships determination, and a plurality of corresponding channels, for example.

When the notice from the analyzer 32 is received, the display processor 24 may display the result of the plural ships determination by the analyzer 32 on the screen based on the notice. In more detail, in the plural ships determination by the analyzer 32, when the plurality of channels are determined to be respectively used for the propagation of the radio waves for voice from the plurality of ships, the display processor 24 may display on the screen the plurality of channels and discernment information on the plurality of ships so as to be associated with each other.

In detail, as illustrated in FIG. 5, the display processor 24 may display the text “SHIP A” indicating that the radio wave for voice using the channel “CH15” is transmitted from a first ship, around the frequency component corresponding to this radio wave for voice. Further, the display processor 24 may display the text “SHIP B” indicating that the radio wave for voice using the channel “CH17” is transmitted from a second ship, around the frequency component corresponding to this radio wave for voice.

Note that the analyzer 32 may perform the plural ships determination by using other methods. For example, when the plurality of radio waves for voice transmitted from ships using different channels differ in the level, the analyzer 32 may determine that the plurality of radio waves for voice are respectively transmitted from a plurality of ships.

### (Indication of Rate of Use of Channel)

Referring back to FIG. 6, the display processor 24 may recognizably display on the screen a rate of use per unit time for every channel which may be used. The unit time may be the same length as the display period selected by the user.

For example, when operation for setting the display period of the screen to one hour is performed by the user, the display processor 24 may calculate the rate of use per hour for the last one hour for every channel, and display the calculated rate as the rate of use. In detail, the display processor 24 may display the rates of use, such as “0%” and “30%” inside the graphic symbols S1-S9 respectively corresponding to the channels “CH11” to “CH19.”

Note that the analyzer 32 may perform a part of the various determinations related to the radio wave for voice, instead of performing all the various determinations.

Further, the display processors 24 may not perform at least any one of the indication of the available channel, the change in the display period, and the indication of the rate of use of the channel.

Further, the display processor 24 may display on the screen text or a symbol indicative of a time-series change in the status of use for every channel, instead of performing the spectrum indication of the radio wave for voice.

### <Flow of Operation>

The display processing device according to the embodiment of the present disclosure may be provided with a computer including a memory, and an arithmetic processor, such as a CPU, in this computer may read from the memory a program including a part or all of each step of the following flowchart and sequence, and execute it. This program may be installable from an external device. This program may be circulated in a state where it is stored in a recording medium, or via a communication line or network.

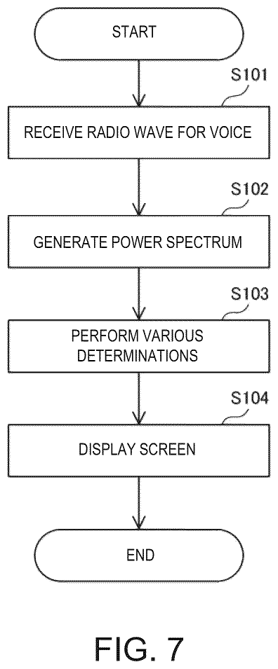

FIG. 7 is a flowchart defining one example of an operation procedure when the display processing device according to the embodiment of the present disclosure displays the screen indicative of the time-series change in the status of use for every channel.

Referring to FIG. 7, first, the receiver 22 may receive the radio wave for voice transmitted from the wireless radio 10 via the antenna 21, convert the received radio wave for voice into a digital signal, and output it to the analysis processor 23 (Step S101).

Next, the FFT processor 31 in the analysis processor 23 may generate the power spectrum by performing FFT processing to the digital signal received from the receiver 22, and output the generated power spectrum to the analyzer 32 and the display processor 24 (Step S102).

Next, the analyzer 32 may perform the various determinations about the radio wave for voice, such as the determination of the channel used for the propagation of the radio wave for voice received by the receiver 22, based on the power spectrum outputted from the FFT processor 31, and output the determination results to the display processor 24 (Step S103).

Then, the display processor 24 may display on the display unit 25 the screen indicative of the time-series change in the status of use for every channel which may be used, based on the power spectrum outputted from the FFT processor 31, and the result of the various determinations for the radio wave for voice outputted from the analyzer 32 (Step S104).

Meanwhile, when the voice wireless communications are performed between a plurality of ships, or between a ship and a land station, the exclusive channel determined between the users may have already been used by others. In such a case, since the radio wave for voice containing voice data transmitted from each wireless radio which performs the voice wireless communications interferes with the radio wave transmitted from other wireless radios which have already used this exclusive channel, it becomes difficult to catch the conversation voices. Therefore, the voice wireless communications become difficult to perform normally. For this reason, it becomes necessary to again determine the exclusive channel between the users, which requires more time and effort.

Further, since the wireless radios are generally limited by their hardware configurations in the number of channels which can be used simultaneously, it is difficult to grasp in parallel the status of use of all the usable channels.

On the other hand, in the display processing device 201 according to the embodiment of the present disclosure, the receiver 22 may receive the radio wave for voice. The analysis processor 23 may determine the channel used for the propagation of the radio wave for voice received by the receiver 22. The display processor 24 may display the screen indicative of the time-series change in the status of use for every channel which may be used, based on the analysis result by the analysis processor 23. Further, the analysis processor 23 may perform the ship/land determination for determining whether the output source of the radio wave for voice received by the receiver 22 is either a ship or a land station. Moreover, the display processor 24 may display the result of the ship/land determination by the analysis processor 23 on the screen.

Thus, according to the configuration for displaying the screen indicative of the time-series change in the status of use for every channel which may be used, the user of each wireless radio 10 which performs voice wireless communications can select the exclusive channel, after grasping the currently-used channel by checking the screen displayed by the display processing device 201.

Further, according to the configuration for displaying on the screen whether the output source of the radio wave for voice is either a ship or a land station, the user of each wireless radio 10 can estimate the purpose of use of the currently-used channel, and thus can select a more suitable exclusive channel. Therefore, the interference when performing the voice wireless communications between a plurality of ships, or between a ship and a land station can be prevented, and normal voice wireless communications can be started smoothly.

Further, the analysis processor 23 may perform the ship/land determination based on the degree of noise in the radio wave for voice received by the receiver 22.

By such a configuration, the ship/land determination can be performed easily and correctly, without performing complicated processing to the radio wave for voice.

Further, the analysis processor 23 may perform the plural ships determination for determining whether a plurality of different channels are respectively used for the propagation of the radio waves for voice from a plurality of ships. Further, in the plural ships determination by the analysis processor 23, when the plurality of channels are determined to be respectively used for the propagation of the radio waves for voice from the plurality of ships, the display processor 24 may display on the screen the plurality of channels and the discernment information on the plurality of ships so as to be associated with each other.

By such a configuration, the user of each wireless radio 10 can grasp the more detailed statuses of use of the channel by one or more ships by checking the screen displayed by the display processing device 201.

Further, the analysis processor 23 may perform the channel change determination for determining that the change in the channel is made in the ship, when the radio waves for voice from the same ship are continuously received by the receiver 22 between the plurality of different channels. The display processor 24 may further display on the screen the result of the channel change determination by the analysis processor 23.

By such a configuration, the user of each wireless radio 10 can grasp the more detailed statuses of use of the channel by one or more ships by checking the screen displayed by the display processing device 201.

Further, in the channel change determination, when a difference between the reception end time at the receiver 22 of the radio wave for voice using the first channel from a ship and the reception start time at the receiver 22 of the radio wave for voice using the second channel from a ship after the reception end time is less than the given value, the analysis processor 23 may determine that the radio waves for voice from the same ship are continuously received by the receiver 22 between the different channels.

By such a configuration, the more exact channel change determination can be performed using the time-series changes in the status of use of the plurality of channels.

Further, in the channel change determination, the analysis processor 23 may analyze the noise in the radio wave for voice received by the receiver 22, and based on the analysis result, it may determine that the radio waves for voice from the same ship are continuously received by the receiver 22 between the different channels.

By such a configuration, the channel change determination can be performed easily and correctly, without performing complicated processing to the radio wave for voice.

Further, the analysis processor 23 may analyze the voice data contained in the radio wave for voice received by the receiver 22, and based on the analysis result, it may perform the channel change determination for determining whether the change in the channel is made in the ship. Further, the display processor 24 may display on the screen the result of the channel change determination by the analysis processor 23.

By such a configuration, the user of each wireless radio 10 can grasp the more detailed statuses of use of the channel by one or more ships by checking the screen displayed by the display processing device 201.

Further, the analysis processor 23 may perform the broadcast determination for determining whether the radio wave for voice received by the receiver 22 is the radio wave used for broadcast from a land station. Further, the display processor 24 may display on the screen the result of the broadcast determination by the analysis processor 23.

By such a configuration, the user of each wireless radio 10 can grasp the purpose of use of the currently-used channel more accurately by checking the screen displayed by the display processing device 201.

Further, in the broadcast determination, when the radio wave for voice from the land station is continuously received by the receiver 22 for more than the given period of time, the analysis processor 23 may determine that it is the radio wave used for broadcast from a land station.

By such a configuration, the more exact broadcast determination can be performed using the time-series change in the status of use of the channel.

Further, the display processor 24 may recognizably display the currently-unused channel on the screen among the plurality of channels which may be used.

By such a configuration, the user of each wireless radio 10 can select the exclusive channel which can prevent the generation of interference more easily by checking the screen displayed by the display processing device 201.

Further, the display processor 24 may recognizably display on the screen the rate of use per unit time for every channel which may be used.

By such a configuration, the user of each wireless radio 10 can select the more suitable exclusive channel after grasping the more detailed statuses of use of the plurality of channels by checking the screen displayed by the display processing device 201.

Further, the display processing method according to the embodiment of the present disclosure is a display processing method in the display processing device 201. According to this display processing method, the receiver 22 may first receive the radio wave for voice. Next, the analysis processor 23 may perform the determination of the channel used for the propagation of the radio wave for voice received by the receiver 22, and the ship/land determination for determining whether the output source of the received radio wave for voice is either a ship or a land station. Next, the display processor 24 may further display the screen indicative of the time-series change in the status of use for every channel which may be used, based on the result of the channel determination by the analysis processor 23, and may further display on the screen the result of the ship/land determination by the analysis processor 23.

Thus, according to the method which displays the screen indicative of the time-series change in the status of use for every channel which may be used, the user of each wireless radio 10 which performs the voice wireless communications can select the exclusive channel, after grasping the currently-used channel by checking the screen displayed by the display processing device 201.

Further, according to the method which displays on the screen whether the output source of the radio wave for voice is either a ship or a land station, the user of each wireless radio 10 can select the more suitable exclusive channel after estimating the purpose of use of the currently-used channel. Therefore, the generation of interference when performing the voice wireless communications between a plurality of ships, or between a ship and a land station can be prevented, and the normal voice wireless communications can be started smoothly.

The above embodiment is illustrative in all aspects, and it should be considered not to be restrictive. The scope of the present disclosure is illustrated not by the above description but by the appended claims, and it is intended to include all the changes within the claims, and the meaning and the scope equivalent to the claims.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately,” “about,” and “substantially” as used herein include the recited numbers, and also represent an amount close to the stated amount that still performs a desired function or achieves a desired result. For example, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

### DESCRIPTION OF REFERENCE CHARACTERS

10, 10A-10C: Wireless Radio
20: Controller
21: Antenna
22: Receiver
23: Analysis Processor
24: Display Processor
25: Display Unit
31: FFT Processor
32: Analyzer
201: Display Processing Device
S1-S9: Graphic Symbol

What is claimed is:

1. A display processing device, comprising:
a receiver configured to receive a radio wave for voice;
processing circuitry configured to;
perform a determination of a channel used for propagation of the radio wave for voice and a ship/land determination for determining whether an output source of the radio wave for voice is either one of a ship and a land station, and
display, on a screen indicative of a time-series change in the status of use for every channel that may be used, a result of the ship/land determination for the used channel.

2. The display processing device of claim 1, wherein the processing circuitry performs the ship/land determination based on a degree of noise in the radio wave for voice.

3. The display processing device of claim 1, wherein the processing circuitry further performs a plural ships determination for determining whether a plurality of different channels are respectively used for propagation of radio waves for voice from a plurality of ships, and
wherein, in the plural ships determination, when the plurality of channels are determined to be respectively used for the propagation of the radio waves for voice from the plurality of ships, the processing circuitry further displays on the screen the plurality of channels and discernment information on the plurality of ships so as to be associated with each other.

4. The display processing device of claim 1, wherein, when radio waves for voice from the same ship are continuously received by the receiver in a plurality of different channels, the processing circuitry further performs a channel change determination for determining that a change in the channel is made in the ship, and
wherein the processing circuitry further displays the result of the channel change determination on the screen.

5. The display processing device of claim 4, wherein, in the channel change determination, when a difference between a reception end time at the receiver of the radio wave for voice using a first channel from a ship, and a reception start time at the receiver of the radio wave for voice using a second channel from a ship after the reception end time is less than a given value, the processing circuitry determines that the radio waves for voice from the same ship are continuously received by the receiver in the plurality of different channels.

6. The display processing device of claim 4, wherein, in the channel change determination, the processing circuitry analyzes noise in the radio wave for voice received by the receiver, and based on the analysis result, determines that the radio waves for voice from the same ship are continuously received by the receiver in the plurality of different channels.

7. The display processing device of claim 1, wherein the processing circuitry further analyzes voice data contained in the radio wave for voice received by the receiver, and based on the analysis result, the analysis processor performs a channel change determination for determining whether a change in the channel is made in the ship, and
wherein the processing circuitry further displays the result of the channel change determination on the screen.

8. The display processing device of claim 1, wherein the processing circuitry further performs a broadcast determination for determining whether the radio wave for voice received by the receiver is a radio wave used for broadcast from a land station, and wherein the processing circuitry further displays the result of the broadcast determination on the screen.

9. The display processing device of claim 2, wherein the processing circuitry further performs a broadcast determination for determining whether the radio wave for voice received by the receiver is a radio wave used for broadcast from a land station, and
wherein the processing circuitry further displays the result of the broadcast determination on the screen.

10. The display processing device of claim 3, wherein the processing circuitry further performs a broadcast determination for determining whether the radio wave for voice received by the receiver is a radio wave used for broadcast from a land station, and
wherein the processing circuitry further displays the result of the broadcast determination on the screen.

11. The display processing device of claim 4, wherein the processing circuitry further performs a broadcast determination for determining whether the radio wave for voice received by the receiver is a radio wave used for broadcast from a land station, and
wherein the processing circuitry further displays the result of the broadcast determination on the screen.

12. The display processing device of claim 8, wherein, in the broadcast determination, when the radio wave for voice from a land station is continuously received by the receiver for more than a given period of time, the processing circuitry determines that the radio wave for voice is a radio wave used for broadcast from the land station.

13. The display processing device of claim 1, wherein the processing circuitry further recognizably displays on the screen a currently-unused channel among a plurality of channels that may be used.

14. The display processing device of claim 2, wherein the processing circuitry further recognizably displays on the screen a currently-unused channel among a plurality of channels that may be used.

15. The display processing device of claim 3, wherein the processing circuitry further recognizably displays on the screen a currently-unused channel among a plurality of channels that may be used.

16. The display processing device of claim 4, wherein the processing circuitry further recognizably displays on the screen a currently-unused channel among a plurality of channels that may be used.

17. The display processing device of claim 1, wherein the processing circuitry further recognizably displays on the screen a rate of use per unit time for every channel that may be used.

18. A display processing method in the display processing device, comprising the steps of:
receiving a radio wave for voice;
performing a determination of a channel used for propagation of the radio wave for voice, and a ship/land determination for determining whether an output source of the radio wave for voice is either one of a ship and a land station; and
displaying, on a screen indicative of a time-series change in the status of use for every channel that may be used, a result of the ship/land determination for the used channel.
